(19) United States
(12) Patent Application Publication
(10) Pub. No.: US 2010/0079582 A1
(43) Pub. Date: Apr. 1, 2010

(54) Method and System for Capturing and Using Automatic Focus Information

(76) Inventors: Clay A. Dunsmore, Le Rouret (FR); Madhukar Budagavi, Plano, TX (US)

Correspondence Address: TEXAS INSTRUMENTS INCORPORATED, P O BOX 655474, M/S 3999, DALLAS, TX, 75265, US

(21) Appl. No.: 12/243,104

(22) Filed: Oct. 1, 2008

(51) Int. Cl. H04N 13/02; H04N 5/232

(52) U.S. Cl. 348/46; 348/345; 348/E13.074; 348/E05.042

(57) ABSTRACT

Methods and digital image capture devices are provided for capturing and using automatic focus information. Methods include building a three dimension (3D) focus map for a digital image on a digital image capture device, using the 3D focus map in processing the digital image, and storing the digital image. Digital image capture devices include a processor, a lens, a display operatively connected to the processor, means for automatic focus operatively connected to the processor and the lens, and a memory storing software instructions, wherein when executed by the processor, the software instructions cause the digital image capture device to initiate capture of a digital image, build a three dimension (3D) focus map for the digital image using the means for automatic focus, and complete capture of the digital image.

### BACKGROUND OF THE INVENTION

Digital cameras are becoming more and more sophisticated, providing many advanced features including noise filtering, instant red-eye removal, high-quality prints extracted from video, image and video stabilization, in-camera editing of photographs (i.e., digital images), and wireless transmission of photographs. However, the availability and capability of these advanced features on a digital camera is controlled by the cost of the digital camera. That is, the availability and capability of such features depends on the processing power of the digital camera, which is a large component of the cost.

For example, red-eye, the appearance of an unnatural reddish coloration of the pupils of a subject appearing in an image, is a frequently occurring problem in flash photography. Redeye is caused by light from the flash reflecting off blood vessels in the subject's retina and returning to the camera. There are algorithms that may be used to locate and correct red eyes in a captured digital image. However, these algorithms are typically very complex and require more processing power for adequate performance that is available on many digital cameras.

In another example, the ability to differentiate foreground subjects from background objects is useful in editing of digital images, both for in-camera editing and off-camera editing. One approach for differentiating foreground from background is to use an unnatural color backdrop when capturing the digital image. Another approach is to extract the foreground subject by finding its outline. However, this approach requires user guidance to the extraction algorithm to “find” the subject in the scene. While automatic extraction algorithms exist, they require more processing power than is available on most digital cameras and are typically not available in consumer applications used for editing digital images.

### SUMMARY OF THE INVENTION

Embodiments of the invention provide methods and system for capturing information from an automatic focus process in a digital image capture device (e.g., a digital camera) for use in further processing of the captured digital images. More specifically, embodiments of the invention create and store a three dimensional (3D) focus map during the image capture process of a digital image capture device. The 3D focus map is created as a part of the automatic focus process during image capture. The 3D focus map may then be used in further processing of the captured digital image such as, for example, red-eye detection and correction and subject extraction. The further processing of the captured digital image may be performed on the digital image capture device that captures the digital image or on another digital system. In some embodiments, the 3D focus map is stored in association with the captured digital image on removable storage media.

### BRIEF DESCRIPTION OF THE DRAWINGS

Particular embodiments in accordance with the invention will now be described, by way of example only, and with reference to the accompanying drawings:

FIGS. 1A and 1B show block diagrams an illustrative digital system and an image pipeline in accordance with one or more embodiments of the invention;

FIG. 2 shows a flow diagram of a method in accordance with one or more embodiments of the invention;

FIGS. 3A-3E show an example in accordance with one or more embodiments of the invention;

FIGS. 4A-4E show an example in accordance with one or more embodiments of the invention;

FIG. 5 shows an illustrative digital system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

In general, embodiments of the invention provide methods and systems for capturing focus information during the automatic focus process of a digital image capture device for use in further processing of captured digital images. More specifically, embodiments of the invention provide for building a three dimensional (3D) focus map of the scene in a digital image during the automatic focus process performed when a digital image is being captured. This 3D focus map is stored and may then be used by other processes in the digital image capture device (or by applications on other digital systems that are used to process captured digital images) to analyze and possibly change the captured digital image. For example, the 3D focus map may be used by a subject extraction process to differentiate foreground subjects from background objects in the captured digital image or by a red eye reduction process to bind the sizes of faces it is looking for in the captured digital image.

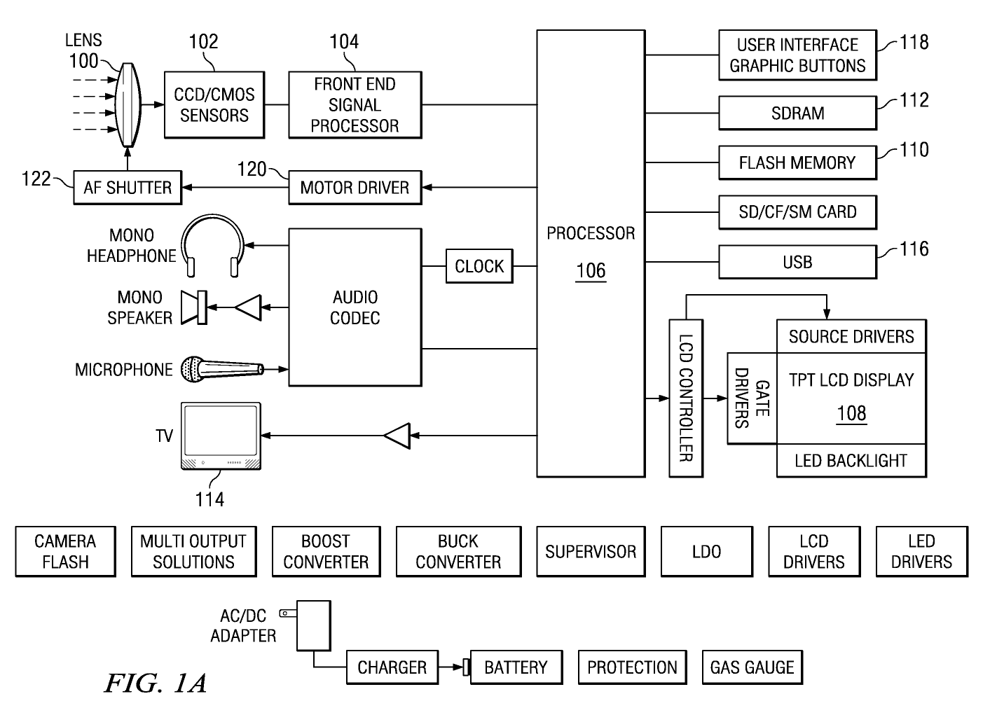

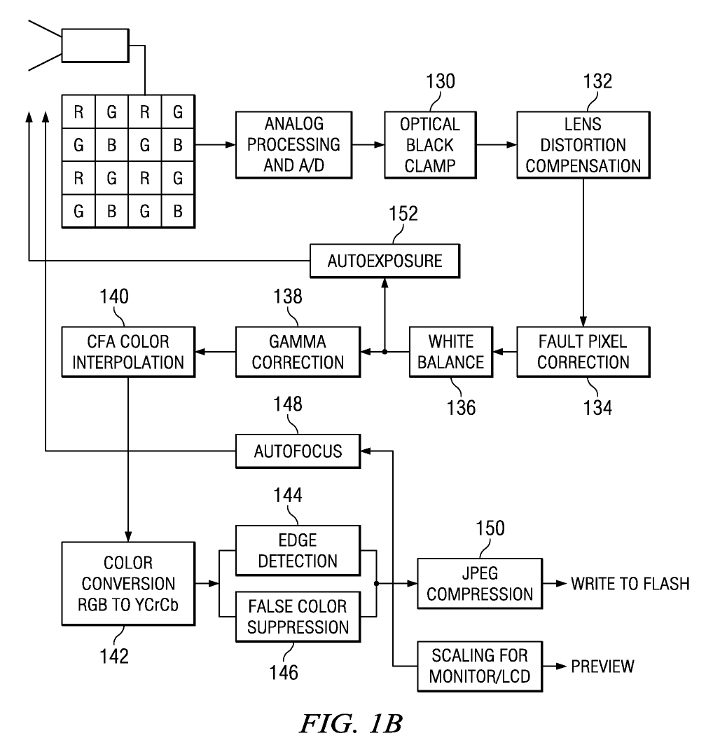

FIG. 1A is an example of digital image capture device that may include systems and methods for capturing and using automatic focus (autofocus) information as described below. Specifically, FIG. 1A is a block diagram of a digital still camera (DSC) in accordance with one or more embodiments of the invention.

The basic elements of the DSC of FIG. 1A include a lens (100), image sensors such as CCD/CMOS sensors (102) to sense images, and a processor (106), which may be a digital signal processor (DSP) for processing the image data supplied from the sensors (102). Additional circuitry, such as a front end signal processor (104), provides functionality to acquire a good-quality signal from the sensors (102), digitize the signal, and provide the signal to the processor (106). The processor (106) provides the processing power to perform the image processing and compression operations involved in capturing digital images. That is, the processor (106) executes image processing software programs stored in read-only memory (not specifically shown) and/or external memory (e.g., SDRAM (112)). The image processing and control is described in more detail below in reference to FIG. 1B. The DSC also includes automatic focus circuitry such as motor driver (120) and autofocus shutter (122). This automatic focus circuitry is driven in a feedback loop by image processing software executing on the processor (106) to automatically focus the DSC. This autofocus process is described in more detail below in relation to FIG. 1B.

The DSC also includes an LCD display (108) for displaying captured images and removable storage (e.g., flash memory (110)) for storing captured images. Image data may be stored in any of a number of different formats supported by the DSC including, but not limited to, GIF, JPEG, BMP (Bit Mapped Graphics Format), TIFF, FlashPix, etc. In some embodiments of the invention, the DSC also includes an interface for viewing or previewing the captured images on external display devices (e.g., TV (114)). Further, in one or more embodiments of the invention, the DSC includes a Universal Serial Bus (USB) port (116) for connecting to external devices such as personal computers and printers. Using such ports, the captured digital images may be transferred to other devices for further processing, storage, and/or printing. The DSC may also include various user interface buttons (118) that a user may use in conjunction with user configuration and control software executing on the processor to configure various features of the DSC.

FIG. 1B is a block diagram illustrating DSC control and image processing (the “image pipeline”) in accordance with one or more embodiments of the invention. One of ordinary skill in the art will understand that similar functionality may also be present in other digital systems (e.g., a cell phone, PDA, etc.) capable of capturing digital images. The image-processing pipeline performs the baseline and enhanced image processing of the DSC, taking the raw data produced by the sensors (102) and generating the digital image that is viewed by the user or undergoes further processing before being saved to memory. In general, the pipeline is a series of specialized algorithms that adjusts image data in real-time.

In one or more embodiments of the invention, the image-processing pipeline is designed to exploit the parallel nature of image-processing algorithms and enable the DSC to process multiple digital images simultaneously while maximizing final image quality. Additionally, each state in the pipeline begins processing as soon as image data is available. That is, the entire image does not have to be received from the previous sensor or stage before processing in the next stage begins. This results in an efficient pipeline with deterministic performance that increases the speed with which digital images are processed, and therefore the rate at which digital images may be captured.

The automatic focus, automatic exposure, and automatic white balancing are referred to as the 3A functions; and the image processing includes functions such as color filter array (CFA) interpolation, gamma correction, white balancing, color space conversion, and JPEG/MPEG compression/decompression (JPEG for single images and MPEG for video clips). A brief description of the function of each block in accordance with one or more embodiments is provided below. Note that the typical color CCD consists of a rectangular array of photosites (pixels) with each photosite covered by a filter (the CFA): typically, red, green, or blue. In the commonly-used Bayer pattern CFA, one-half of the photosites are green, one-quarter are red, and one-quarter are blue.

To optimize the dynamic range of the pixel values represented by the CCD imager of the digital camera, the pixels representing black need to be corrected since the CCD cell still records some non-zero current at these pixel locations. In some embodiments of the invention, the black clamp function (130) adjusts for this difference by subtracting an offset from each pixel value, but clamping/clipping to zero to avoid a negative result.

Imperfections in the digital camera lens introduce nonlinearities in the brightness of the image. These nonlinearities reduce the brightness from the center of the image to the border of the image. In one or more embodiments of the invention, the lens distortion compensation function (132) compensates for the lens by adjusting the brightness of each pixel depending on its spatial location.

Large-pixel CCD arrays may have defective pixels. The fault pixel correction function (134) interpolates the missing pixels with an interpolation scheme to provide the rest of the image processing data values at each pixel location.

The illumination during the recording of a scene is different from the illumination when viewing a picture. This results in a different color appearance that is typically seen as the bluish appearance of a face or the reddish appearance of the sky. Also, the sensitivity of each color channel varies such that grey or neutral colors are not represented correctly. In one or more embodiments of the invention, the white balance function (136) compensates for these imbalances in colors by computing the average brightness of each color component and by determining a scaling factor for each color component. Since the illuminants are unknown, a frequently used technique just balances the energy of the three colors. This equal energy approach requires an estimate of the unbalance between the color components.

Display devices used for image-viewing and printers used for image hardcopy have a nonlinear mapping between the image gray value and the actual displayed pixel intensities. In one or more embodiments of the invention, the gamma correction function (138) compensates for the differences between the images generated by the CCD sensor and the image displayed on a monitor or printed into a page.

Due to the nature of a color filtered array, at any given pixel location, there is only information regarding one color (R, G, or B in the case of a Bayer pattern). However, the image pipeline needs full color resolution (R, G, and B) at each pixel in the image. In one or more embodiments of the invention, the CFA color interpolation function (140) reconstructs the two missing pixel colors by interpolating the neighboring pixels.

Typical image-compression algorithms such as JPEG operate on the YCbCr color space. In one or more embodiments of the invention, the color space conversion function (142) transforms the image from an RGB color space to a YCbCr color space. This conversion is a linear transformation of each Y, Cb, and Cr value as a weighted sum of the R, G, and B values at that pixel location.

The nature of CFA interpolation filters introduces a low-pass filter that smoothes the edges in the image. To sharpen the images, in one or more embodiments of the invention, the edge detection function (144) computes the edge magnitude in the Y channel at each pixel. The edge magnitude is then scaled and added to the original luminance (Y) image to enhance the sharpness of the image.

Edge enhancement is only performed in the Y channel of the image. This leads to misalignment in the color channels at the edges, resulting in rainbow-like artifacts. In one or more embodiments of the invention, the false color suppression function (146) suppresses the color components, Cb and Cr, at the edges reduces these artifacts.

In one or more embodiments of the invention, the autofocus function (148) automatically adjusts the lens focus in the DSC through image processing. As previously mentioned, the autofocus mechanisms operate in a feedback loop. Image processing is performed to detect the quality of lens focus and move the lens motor iteratively until the image comes sharply into focus. More specifically, the sensors (102) provide input to algorithms that compute the contrast of the actual digital image elements. A CCD sensor may be a strip of pixels. Light from the scene to be captured hits this strip and the processor (106) looks at the values from each pixel. That is, autofocus software executing on the processor (106) looks at the strip of pixels and looks at the difference in intensity among the adjacent pixels. If the scene is out of focus, adjacent pixels have very similar intensities. The autofocus software moves the lens, looks at the CCD's pixels again and sees if the difference in intensity between adjacent pixels improved or got worse. The autofocus software then searches for the point where there is maximum intensity difference between adjacent pixels which is the point of best focus.

Due to varying scene brightness, to get a good overall image quality, the exposure of the CCD is controlled. In one or more embodiments of the invention, the autoexposure function (152) senses the average scene brightness and appropriately adjusts the CCD exposure time and/or gain. Similar to autofocus, this function also operates in a closed-loop feedback fashion.

The amount of memory available on the DSC is limited; hence, in one or more embodiments of the invention, the image compression function (150) is employed to reduce the memory requirements of captured images. In some embodiments of the invention, compression ratios of about 10:1 to 15:1 are used. After each captured digital image is compressed, it is stored to a removable memory such as flash memory (110).

In one or more embodiments of the invention, the autofocus function (148) includes functionality to build a three dimensional (3D) focus map of the scene to be captured as a digital image. For the x and y dimensions of the 3D focus map, the scene is divided into a number of focus windows. In one or more embodiments of the invention, the number of focus windows is determined by the mode of the digital camera selected by the user. That is, the number of focus windows used to build the 3D focus map is the same number of focus windows used by the autofocus process and this number is determined by current mode of the digital camera. For example, the scene may be divided in thirty-six windows in the x dimension and thirty-six windows in the y dimension giving a total of 1296 windows. The z dimension (depth) is added by stepping the lens focus system from near focus to far focus in discrete steps (i.e., focus distances) and capturing a focus value for each of the windows at each discrete lens focus distance. In one or more embodiments, the number of focus distances and the sizes of the focus distances used depend on capabilities of the digital camera such as total focus range (near focus, far focus), focal length of the lens (zoom lenses need many more focus positions), F# of the lens (bright apertures, small numbers like F2.8 need more positions than F11), and pixel size of the sensor. For example, twenty discrete focus distances may be used and a focus value for each of the 1296 windows may be captured at each of these twenty focus distances.

A focus value is a relative measurement of how in focus the digital image is or how “sharp” the scene content is at a focus distance. In one or more embodiments of the invention, at each focus distance, a high pass filter is applied to each of the focus windows and the output of the high pass filter is summed inside the focus window to create the focus value for the focus window. The higher the frequency content in the focus window, the larger the output of the high pass filter and the higher the focus value.

Once the 3D focus map is built, it may be stored and used for subsequent processing of the captured digital image. In one or more embodiments of the invention, the 3D focus map is stored to a removable memory in association with the captured digital image. For example, if the storage format is JPEG, the 3D focus map may be stored in the JPEG file of the captured digital image as a custom field. Further, the subsequent use of the 3D focus map may be by other image processing functions on the DSC and/or by image processing applications executing on other digital systems.

In one or more embodiments of the invention, automatic red-eye detection and correction is performed using the 3D focus map built by the autofocus function (148). A stored software program in an onboard or external memory may be executed to implement the automatic red-eye detection and correction. The red-eye detection and correction algorithm includes face detection, red-eye detection, and red-eye correction. The face detection involves detecting facial regions in the given input image. Without information about the scene, face detection has to look for a wide variety of face sizes.

In one or more embodiments of the invention, the variance in face sizes to be considered by face detection is minimized by using the 3D focus map. More specifically, face detection may use the 3D focus map and the lens focal length to determine how far away the scene is in each of the focus windows. Using this information, the face detection algorithm can tightly bound the sizes of faces for which it is searching. The face detection can also use this information to eliminate some areas of the digital image from the search. For example, face detection can determine that some areas are too far away to have red eyes. In some embodiments of the invention, red-eye detection and correction may be performed as a pre-preprocessing step prior to the image compression function (150) or as a post-processing step after the image compression function (150).

In one or more embodiments of the invention, the 3D focus map is used by a scene segmentation algorithm (i.e., subject extraction algorithm) executed by a software application on a separate digital system. For example, the captured digital image along with its 3D focus map may be transferred to the digital system from the DSC so that a user can make changes to the captured digital image in a photograph editing application. One typical change is replacing the background of the captured digital image. When the user requests that the background be changed, as part of the change process, a scene segmentation algorithm included in the application may use the 3D focus map to estimate where foreground subjects are located in the scene.

More specifically, the scene segmentation algorithm can concentrate its efforts (edge extraction) on specific focus windows of the scene in the digital image having the highest combination of focus values at the focus distances used and ignore other windows which only have objects that are in focus at distances other than the subject distance. Once the foreground subjects are identified, the application may replace the background objects with the user's desired background. Thus, the use of the 3D focus map by the scene segmentation algorithm does not require input from the user to identify the foreground subjects and may increase the efficiency and decrease the complexity of the scene segmentation algorithm.

In another example, captured digital images with their corresponding 3D focus maps may be transferred to the digital system to perform object tracking across multiple digital images. The object tracked may be, for example, a car running a red light, a box or other item being carried out of an office, etc. A scene segmentation algorithm may use the 3D focus map to extract an object of interest (e.g., the car, the box, etc.) in a scene of a digital image and then follow that object through scenes in subsequent digital images.

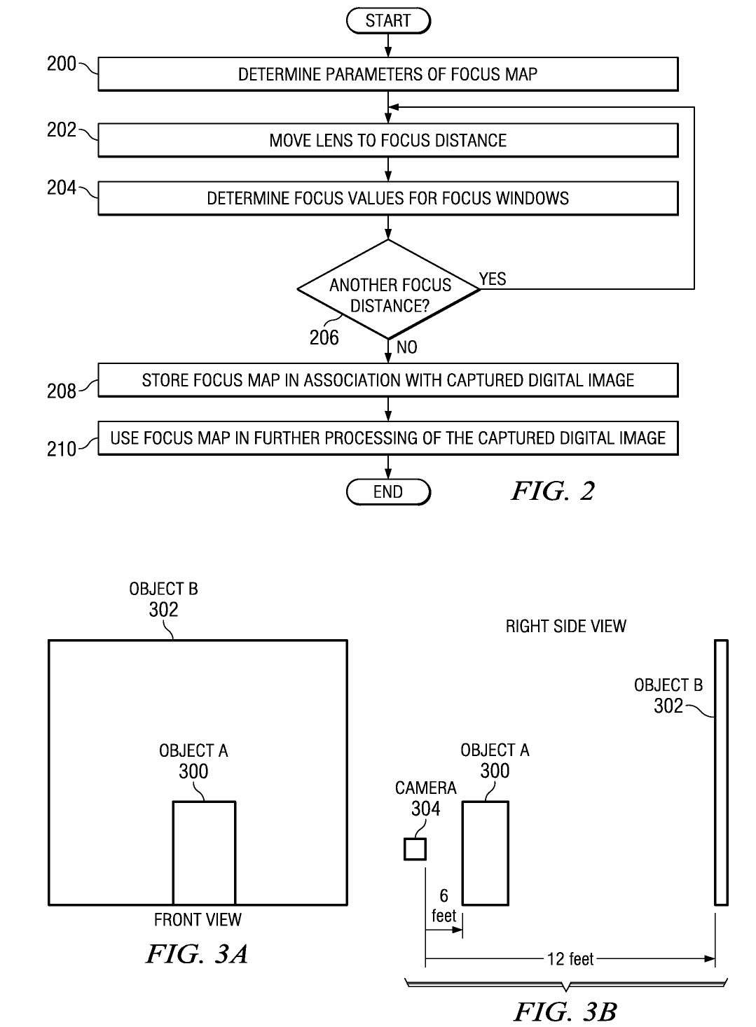

FIG. 2 shows a flow diagram of a method for building and using a 3D focus map in accordance with one or more embodiments of the invention. In one or more embodiments of the invention, this method is performed during automatic focusing of a digital image capture device. In the method, initially the parameters of the 3D focus map to be built are determined (200). The parameters of the 3D focus map are the number of windows into which a scene is to be divided in the x and y directions and a set of discrete focus distances to be used to capture focus values. In some embodiments of the invention, the number of focus windows and the numbers and locations of the focus distances those used during the auto focus process of the digital image capture device. As previously mentioned, these will depend on the selected mode and the particular capabilities of the digital image capture device. In one or more embodiments of the invention, the number of windows and the number and locations of the discrete focus distances may be predetermined, e.g., program constants, or may be user settable parameters. For example, if a user knows that an image processing application to be used for further processing of a digital image prefers to have (or performs better with) a 3D focus map with certain parameters, the user may set parameters in the digital image capture device to cause a map of that size to be built. The actual focus distances to be used may also be predetermined or user settable parameters

Once the parameters are determined, the lens of the digital image capture device is moved to an initial focus distance in the set of discrete focus distances (202). Once the lens is in place, focus values for each of the focus windows are determined and stored (204). The process of moving the lens and determining focus values for the focus windows is repeated for each focus distance in the set of discrete focus distances (202, 204, 206). After this process is complete, the 3D focus map may be stored in association with the captured digital image (208) and/or used in further processing of the captured digital image (210). For example, the 3D focus map may be stored in a file on removable or fixed storage media that also contains the image. The 3D focus map may also be retained in memory for use by other image processing functions of the digital image capture device. In addition, the further processing of the captured digital image using the 3D focus map may occur on the digital image capture device and/or in an application executing on another digital system.

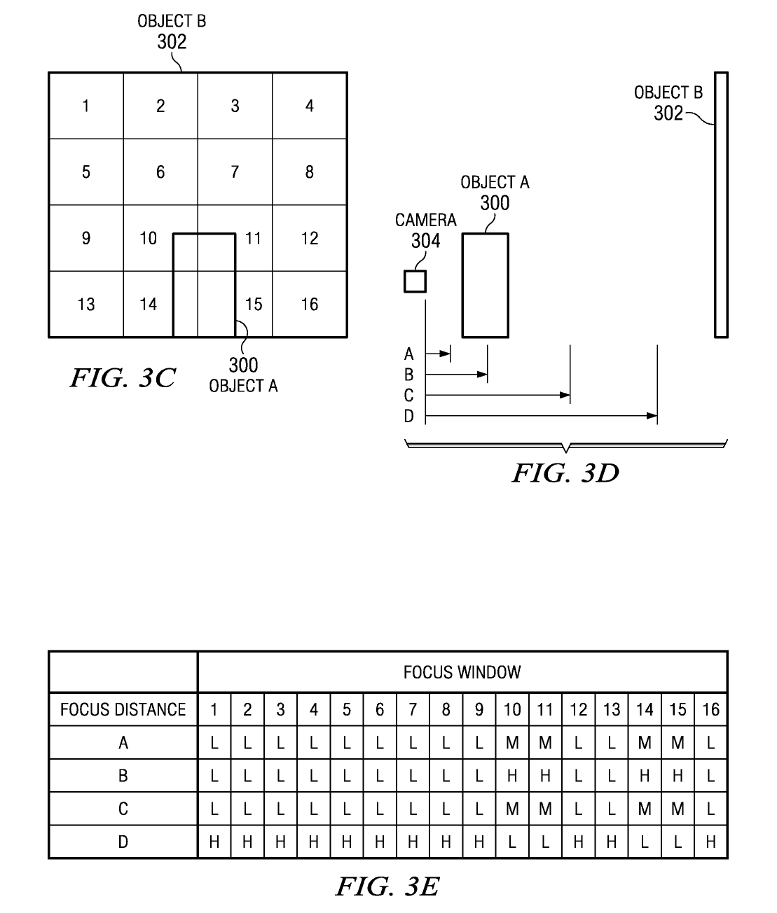

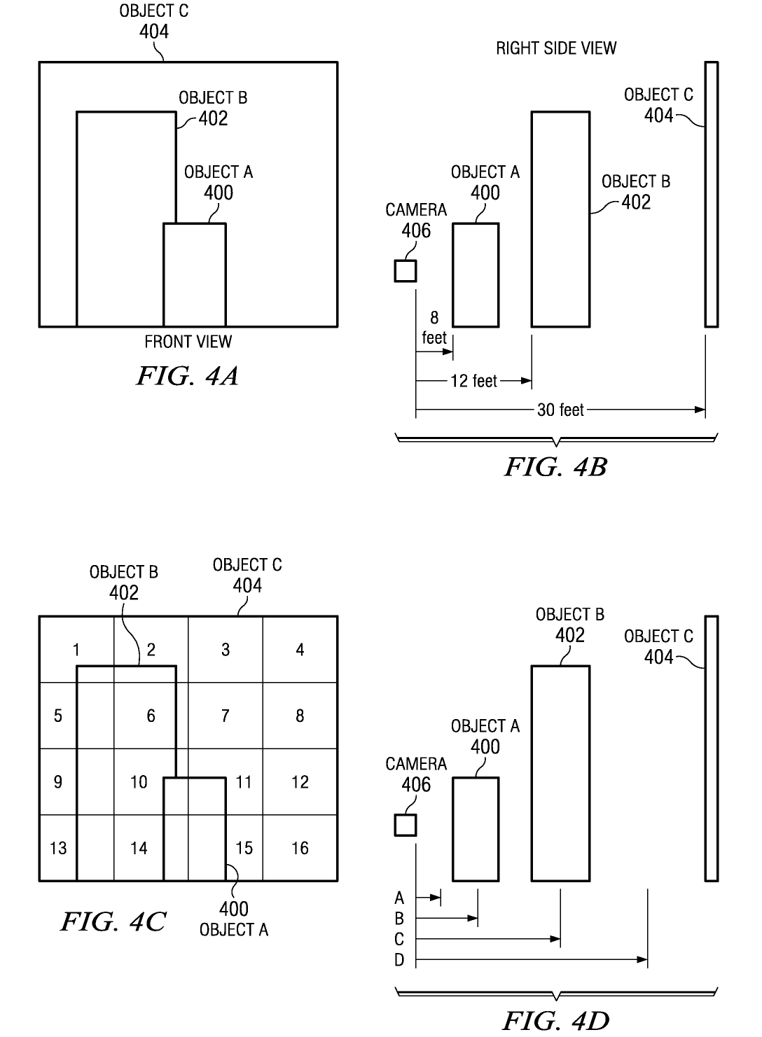

FIGS. 3A to 3E and 4A to 4E show simple examples of capturing and using automatic focus information in accordance with one or more embodiments of the invention. FIG. 3A shows a front view of a simple scene to be captured in a digital image by a camera (304) and FIG. 3B shows a right side view of the scene. The scene includes a foreground object (Object A (300)) and a solid background (Object B (302)). As shown in FIG. 3B, the foreground object (Object A (300)) is six feet from the camera (304) and the background (Object B (302)) is twelve feet from the camera (304). As shown in FIG. 3C, for purposes of building the 3D focus map, the scene is divided into sixteen focus windows, four in the x direction and four in the y direction. As illustrated in FIG. 3D, during the automatic focus process, focus values for these sixteen windows are measured at four focus distances A-D.

To measure at the four focus distances, the lens is moved to each of focus positions A, B, C, and D in succession and a focus value is determined for each of the sixteen focus windows at each focus distance. These focus values are stored until the autofocus process is completed. After the digital image is captured, the focus values are assigned a relative ranking. In this example, the extremes of the focus values are determined and each focus value is ranked as being low (L), medium (M), or high (H) and the ranking is stored. FIG. 3E shows the resulting 3D focus map for the scene. For this simple example of a single object in front of a solid background, the 3D focus map may be used to determine that the foreground object (Object A (300)) is located somewhere between Focus Distances A and C, probably close to Focus Distance B and that the object occupies Focus Windows 10, 11, 14, and 15. To make this determination, an assumption is made that the closest object that is roughly in the center of the scene is the subject of the digital image. Thus, when analyzing the 3D focus map, regions that are in the foreground (higher focus values at the closer focus distances than at the further distances) are sought. The contiguous focus windows with higher focus values will contain the subject.

FIG. 4A shows a front view of a simple scene to be captured in a digital image by a camera (404) and FIG. 4B shows a right side view of the scene. The scene includes a foreground object (Object A (400)), a solid background (Object C (304)), and a third object (Object B (402)) between the foreground object (Object A (400)) and the solid background (Object C (404)). As shown in FIG. 4B, the foreground object (Object A (400)) is six feet from the camera (404), the in-between object (Object B (402)) is twelve feet from the camera (404), and the background (Object C (404)) is thirty feet from the camera (404). As shown in FIG. 4C, for purposes of building the 3D focus map, the scene is divided into sixteen focus windows, four in the x direction and four in the y direction. As illustrated in FIG. 4D, during the automatic focus process, focus values for these sixteen windows are measured at four focus distances A-D.

To measure at the four focus distances, the lens is moved to each of focus positions A, B, C, and D in succession and a focus value is determined for each of the sixteen focus windows at each focus distance. Each focus value is ranked as being low (L), medium (M), or high (H) and the ranking is stored. FIG. 4E shows the resulting 3D focus map for the scene. For this somewhat more complex example of two objects in front of a solid background, the 3D focus map may be used to determine that the foreground object (Object A (400)) is located somewhere between Focus Distances A and C, probably close to Focus Distance B and that the object occupies Focus Windows 10, 11, 14, and 15. The 3D focus map may also be used to determine that the in-between object (Object B (402) is located somewhere between Focus Distances B and D, probably close to Focus Distance C and that the object occupies Focus Windows 1, 2, 5, 6, 9, 10, 13, and 14.

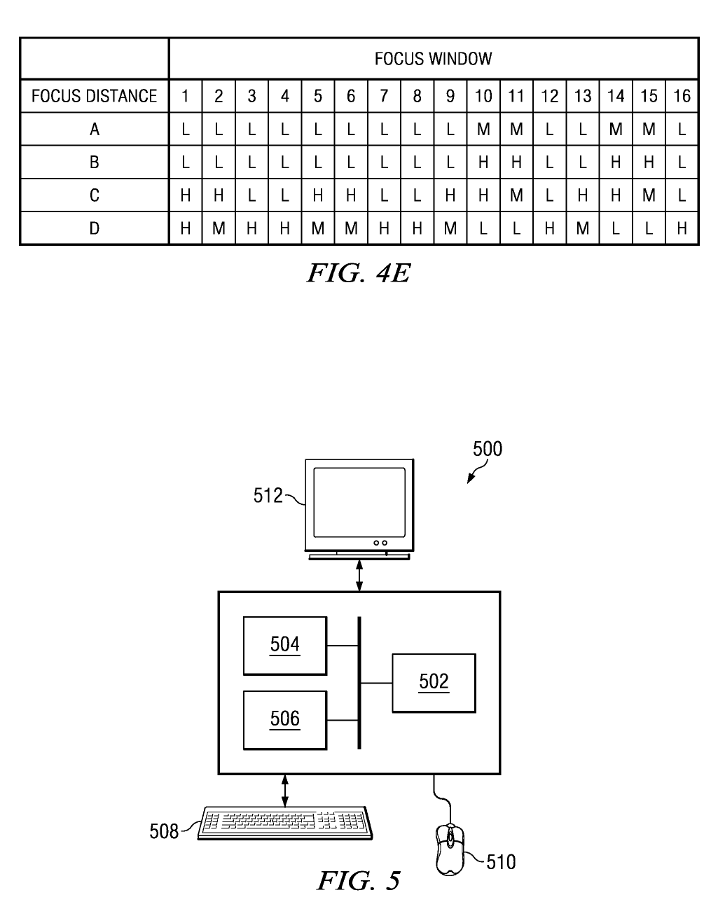

Embodiments of the methods and systems for capturing and using autofocus information described herein may be implemented on virtually any type of digital system (e.g., a desk top computer, a laptop computer, a handheld device such as a mobile (i.e., cellular) phone, a personal digital assistant, a digital camera, an MP3 player, an iPod, etc.) capable of capturing a digital image. Further, embodiments may include a digital signal processor (DSP), a general purpose programmable processor, an application specific circuit, or a system on a chip (SoC) such as combinations of a DSP and a RISC processor together with various specialized programmable accelerators. For example, as shown in FIG. 5, a digital system (500) includes a processor (502), associated memory (504), a storage device (506), and numerous other elements and functionalities typical of today's digital systems (not shown). In one or more embodiments of the invention, a digital system may include multiple processors and/or one or more of the processors may be digital signal processors. The digital system (500) may also include input means, such as a keyboard (508) and a mouse (510) (or other cursor control device), and output means, such as a monitor (512) (or other display device). The digital system ((500)) may also include an image capture device (not shown) that includes circuitry (e.g., optics, a sensor, readout electronics) for capturing digital images. The digital system (500) may be connected to a network (514) (e.g., a local area network (LAN), a wide area network (WAN) such as the Internet, a cellular network, any other similar type of network and/or any combination thereof) via a network interface connection (not shown). Those skilled in the art will appreciate that these input and output means may take other forms.

Further, those skilled in the art will appreciate that one or more elements of the aforementioned digital system (500) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, or any other computer readable storage device. The software instructions may be a standalone program, or may be part of a larger program (e.g., a photograph editing program, a web-page, an applet, a background service, a plug-in, a batch-processing command). The software instructions may be distributed to the digital system (500) via removable memory (e.g., floppy disk, optical disk, flash memory, USB key), via a transmission path (e.g., applet code, a browser plug-in, a downloadable standalone program, a dynamically-linked processing library, a statically-linked library, a shared library, compilable source code), etc. The digital system (500) may access a digital image by reading it into memory from a storage device, receiving it via a transmission path (e.g., a LAN, the Internet), etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method comprising:
building a three dimension (3D) focus map for a digital image on a digital image capture device;
using the 3D focus map in processing the digital image; and
storing the digital image.

2. The method of claim 1, wherein building the 3D focus map is performed as part of automatically focusing the digital image capture device.

3. The method of claim 1, wherein building the 3D focus map further comprises:
positioning a lens of the digital image capture device at each focus distance of a plurality of focus distances; and
determining a focus value for each focus window of a plurality of focus windows at each focus distance.

4. The method of claim 1, wherein storing the digital image further comprises:
storing the 3D focus map in association with the digital image.

5. The method of claim 1, wherein using the 3D focus map further comprises:
performing red-eye detection and correction, wherein the 3D focus map is used to locate a face in the digital image.

6. The method of claim 1, wherein using the 3D focus map further comprises:
performing red-eye detection and correction, wherein the 3D focus map is used to determine areas in the digital image that are too far away for red-eye to be present.

7. The method of claim 1, wherein using the 3D focus map further comprises:
performing scene segmentation on the digital image, wherein the 3D focus map is used to determine a location of a foreground object.

8. The method of claim 1, wherein using the 3D focus map further comprises:
performing face detection wherein the 3D focus map is used to minimize the area searched for faces.

9. A digital image capture device comprising:
a processor;
a lens;
a display operatively connected to the processor;
means for automatic focus operatively connected to the processor and the lens; and
a memory storing software instructions, wherein when executed by the processor, the software instructions cause the digital image capture device to perform a method comprising:
initiating capture of a digital image;
building a three dimension (3D) focus map for the digital image using the means for automatic focus; and
completing capture of the digital image.

10. The digital image capture device of claim 9, wherein the method further comprises:
using the 3D focus map in processing of the digital image.

11. The digital image capture device of claim 10, wherein using the 3D focus map further comprises:
performing red-eye detection and correction, wherein the 3D focus map is used to locate a face in the digital image.

12. The digital image capture device of claim 10, wherein using the 3D focus map further comprises:
performing face detection wherein the 3D focus map is used to minimize the area searched for faces.

13. The digital image capture device of claim 9, wherein building the 3D focus map further comprises:
positioning the lens at each focus distance of a plurality of focus distances; and
determining a focus value for each focus window of a plurality of focus windows at each focus distance.

14. The digital image capture device of claim 9, wherein completing capture of the digital image further comprises:
storing the 3D focus map in association with the digital image.

15. The digital image capture device of claim 9, wherein the digital image capture device is one selected from a group consisting of a digital camera, a cellular telephone, a personal digital assistant, a laptop computer, and a personal computing system.

16. A computer readable medium comprising executable instructions to cause a digital image capture device to:
initiate capture of a digital image;
build a three dimension (3D) focus map for the digital image; and
complete capture of the digital image.

17. The computer readable medium of claim 16, wherein the executable instructions further cause the digital image capture device to:
use the 3D focus map in processing of the digital image.

18. The computer readable medium of claim 16, wherein the executable instructions further cause the digital image capture device to:
perform red-eye detection and correction, wherein the 3D focus map is used to locate a face in the digital image.

19. The computer readable medium of claim 16, wherein the executable instructions further cause the digital image capture device to build the 3D focus map by:
positioning a lens of the digital image capture device at each focus distance of a plurality of focus distances; and
determining a focus value for each focus window of a plurality of focus windows at each focus distance.

20. The computer readable medium of claim 16, wherein the executable instructions further cause the digital image capture device to complete capture of the digital image by:
storing the 3D focus map in association with the digital image.
